(19) United States
(12) Patent Application Publication
(10) Pub. No.: US 2018/0103677 A1
(43) Pub. Date: Apr. 19, 2018

(54) SPICE MARKING METHODS FOR FOODSTUFFS

(71) Applicant: Flavorseal, Avon, OH (US)

(72) Inventors: James L. Smith, North Ridgeville, OH (US); Chris Carroll, Rocky River, OH (US)

(73) Assignee: Flavorseal, Avon, OH (US)

(21) Appl. No.: 15/688,354

(22) Filed: Aug. 28, 2017

Related U.S. Application Data
(60) Provisional application No. 62/409,676, filed on Oct. 18, 2016.

(51) Int. Cl. A23P 20/20

(52) U.S. Cl. CPC A23P 20/20; A23P 2020/253

(57) ABSTRACT

A method of transferring an edible image to a substrate includes mounting a printing plate having an image to a roller; depositing an edible adhesive on the image; transferring the edible adhesive to a substrate; and depositing an edible coating on the adhesive coated substrate thereby transferring a mirror copy of the image onto the substrate. The method may further include placing the edible image in contact with foodstuff and applying pressure or a vacuum to transfer the edible image to the foodstuff. The edible image can be placed onto a foodstuff and light pressure or vacuum can be applied to transfer the image. The foodstuff can be held under pressure or vacuum until the image has transferred.

### RELATED APPLICATION

This application claims the benefit of U.S. Provisional Application No. 62/409,676, filed Oct. 18, 2016, the entire disclosure of which is hereby incorporated by reference.

### FIELD OF THE INVENTION

The general inventive concepts relate to image transfer, more particularly edible seasoning images adhered to sheets, bags, castings and/or shirrs for transfer to foodstuffs.

### BACKGROUND

Seasonings and spices can be added to foodstuffs to impart a desired flavor or taste.

### SUMMARY

Various exemplary embodiments of the present inventive concepts are directed to a method of transferring an edible image to a substrate. In some exemplary embodiments, the method comprises mounting a printing plate having an image thereon to a roller; depositing an edible adhesive onto the printing plate; transferring the edible adhesive from the orienting plate to a substrate; and depositing an edible coating on the substrate thereby forming the edible image on the substrate. In some exemplary embodiments, the edible image comprises the edible adhesive and the edible coating.

In some exemplary embodiments, various exemplary embodiments of the present inventive concepts are directed to a method of transferring an edible image to foodstuff. In certain exemplary embodiments, the method comprises mounting a printing plate having an image thereon to a roller; depositing an edible adhesive onto the image; transferring the edible adhesive from the printing plate to a substrate thereby transferring a mirror copy of the image onto the substrate; depositing an edible coating onto the edible adhesive. In certain exemplary embodiments, the mirror copy of the image comprises the edible adhesive and the edible coating. In certain exemplary embodiments, the method further comprises contacting the substrate with foodstuff; and subjecting the foodstuff to a vacuum until at least a portion of the image transfers to the foodstuff.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

The general inventive concepts, as well as illustrative embodiments and advantages thereof, are described below in greater detail, by way of example, with reference to the drawings in which:

FIG. 1 is an exemplary embodiment of foodstuff with an image;

FIG. 2 is a generalized diagram of an apparatus for transferring an image to a substrate; and

FIG. 3 is a diagram of exemplary embodiments of positive and negative printing plate images.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing particular exemplary embodiments only and is not intended to be limiting of the exemplary embodiments. Accordingly, the general inventive concepts are not intended to be limited to the specific embodiments illustrated herein. Although any methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, processing conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

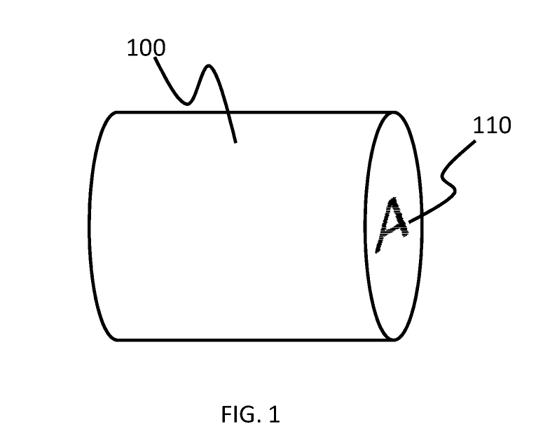

The present disclosure relates to transferring an image to foodstuff. In certain embodiments, the image is edible and formed from a particulate such as spice. It should be apparent to one of skill in the art that other particulates or edible colorings can be used to form the image. In certain exemplary embodiments, the foodstuffs may be a variety of proteins, cheeses, candy, produce, including fruit and vegetables, baked goods, including breads, pastries, cakes, as well as dough for baked goods. In an exemplary embodiment illustrated by FIG. 1, the foodstuff (100) has an image (110) placed on an end piece. In certain exemplary embodiments, the image is edible. Additionally, the edible image (110) may be placed on any portion of the foodstuff (100). In an exemplary embodiment the edible image (110) may be placed on a side, top, bottom, right, left portion of the foodstuff (100) or any combination of these positions.

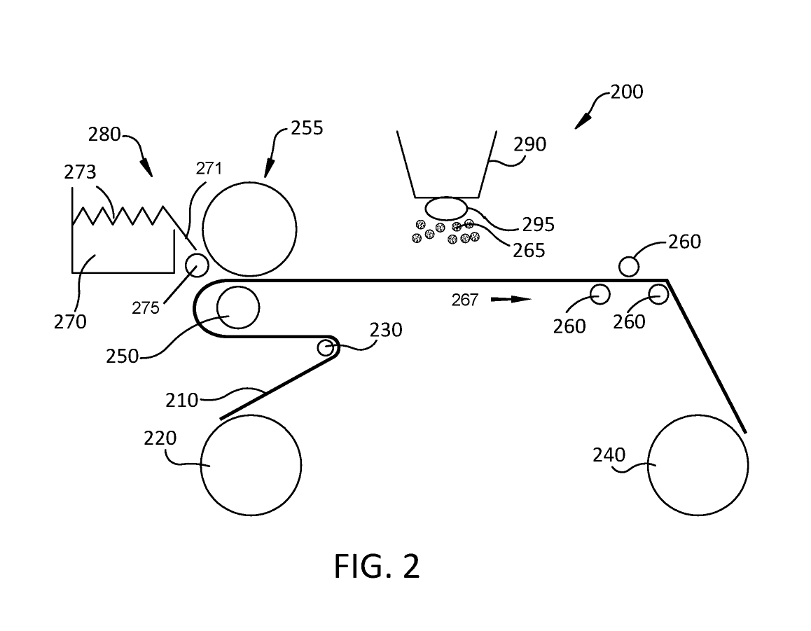

Referring to FIG. 2, prior to the image (110) being transferred to the foodstuff, a method of the current disclosure is used to transfer a spiced image to a substrate (210). In an exemplary embodiment, a machine (200) is used to pull the substrate (200), which is rolled film, from an unwind station (220) to the rewind station (240). In an exemplary embodiment, the unwind station (220) includes a tension bar or tension roller (230) and a drive roller (250). In an exemplary embodiment, the rewind station (240) includes at least one guide roller (260). A variety of substrates may be used, including without limitation, sheets, bags, casings, and/or shirrs. In an exemplary embodiment, the substrate is made from film, parchment, collagen, paper, foil and/or other media.

As the substrate (200) moves through the machine (200), it contacts a printing plate (not shown) that is located on a print roller (255). The printing plate picks up metered amounts of an adhesive discharged from a reservoir (270). In certain exemplary embodiments, the adhesive is edible. A doctor blade (271), a tension controller (273), and an anilox roller (275) form a tensioning system (280) that determines the amount of edible adhesive placed on the printing plate. In certain exemplary embodiments, the metered amount of edible adhesive is deposited or placed on the printing plate. The printing plate is then passed by the doctor blade. The doctor blade is set to a desired height or distance from the plate. As the printing plate passes the doctor blade any excess adhesive is pushed or scraped off the plate, leaving a desired amount of edible adhesive to bind or attached the edible coating. A reverse/mirror copy of the printing plate image is then transferred to the substrate (200). In certain exemplary embodiments, adjustments to the doctor blade tension system (280) may be made to provide a consistent coating on the printing plate.

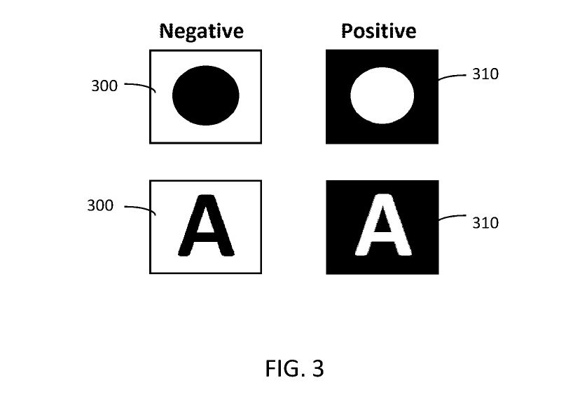

In certain exemplary embodiments, the printing plate is a flexographic printing plate. Referring to FIG. 3, a negative image (300) or positive image (310) can be created on the printing plate. In certain embodiments, the negative image (300) or positive image (310) can be any shape, size, and/or design desired. Referring to FIG. 2, the printing plate can be mounted to the print roller (255). In certain exemplary embodiments, the print roller (255) is an inline flexographic print roller. In certain exemplary embodiments, the printing plate is mounted to the print roller (255) using tape, magnets, straps or another mechanical method. The image on the printing plate is a mirror image of what will be transferred to the substrate.

In certain exemplary embodiments, the reservoir (270) contains an edible adhesive. The edible adhesive can be clear, colored, and/or flavored. The edible adhesive 20 may be, for example, a sugar-based carbohydrate glue. The edible adhesive is used to bond edible coating to substrate (210).

As the substrate (210) continues through the machine (200), the substrate (210) passes a hopper (290). In certain exemplary embodiments, an edible coating (265) is added to a hopper and applied downstream from the edible adhesive image according to the film travel direction (267). In certain exemplary embodiments, the edible coating (265) comprises any edible material. In certain exemplary embodiments, the edible coating (265) comprises sugar, spice, seasoning, color, and/or combinations thereof. In certain exemplary embodiments, the seasonings may be selected to impart any desired flavor to the foodstuff. Some examples of desired flavors are mesquite, lemon pepper, peppercorn, Caribbean jerk, buffalo, chipotle, garlic, sesame ginger, Szechuan, teriyaki, etc. In certain exemplary embodiments, the edible coating (265) comprises starch, salt, vegetable protein, animal protein, yeast, vegetable powder, garlic, garlic powder, fat, gums, preservatives, natural flavors, artificial flavors, any other edible material, and combinations thereof. A mandrel (295) delivers an edible coating (265) in metered quantities to the substrate. The edible coating (265) will bond to the edible adhesive, thus creating an edible image which is bonded to the substrate (210).

The substrate continues through a series of guide rollers (260) and is wound onto a roll in the rewind station (240). The roll is removed and stored in a curing area to allow the product to dry. Cure times vary based on the amount and type of edible adhesive and type of edible coating.

In some exemplary embodiments, the method comprises mounting a printing plate having an image to a roller; depositing an edible adhesive on the image; transferring the edible adhesive to a substrate; and depositing an edible coating on the adhesive coated substrate thereby transferring a mirror copy of the image onto the substrate. In some exemplary embodiments, the method further comprises placing the edible image in contact with foodstuff and applying pressure or a vacuum to transfer the edible image to the foodstuff. In certain exemplary embodiments, the edible image is placed onto a foodstuff and light pressure or vacuum is applied to transfer the image. The foodstuff is held under pressure or vacuum until the image has transferred. In certain exemplary embodiments, the image is partially transferred. In certain exemplary embodiments, the image is transferred completely. In certain exemplary embodiments, the substrate is removed before cooking, if the foodstuff is to be cooked.

As disclosed and suggested herein, the general inventive concepts relate to and contemplate spiced marking for foodstuffs and methods of transferring the same. It will be appreciated that many more detailed aspects of the illustrated processes are in large measure, known in the art, and these aspects have been omitted for purposes of concisely presenting the general inventive concepts.

What is claimed is:

1. A method of transferring an edible image to a substrate comprising:
mounting a printing plate having an image thereon to a roller;
depositing an edible adhesive onto the printing plate;
transferring the edible adhesive from the orienting plate to a substrate; and
depositing an edible coating on the substrate thereby forming the edible image on the substrate, wherein the edible image comprises the edible adhesive and the edible coating.

2. The method of claim 1, wherein the step of transferring the edible image to a substrate comprises contacting the printing plate having the edible adhesive to the substrate; and using the edible adhesive to transfer the image from the printing plate to the substrate;

3. The method of claim 1, further comprising:
placing the edible image in contact with foodstuff; and
applying greater than atmospheric pressure the edible image to transfer the edible image to the foodstuff.

4. The method of claim 1, wherein the foodstuff is selected from the group consisting of protein, cheese, candy, fruit, vegetable, baked goods, bread, pastry, cake, and dough.

5. The method of claim 1, wherein a doctor blade, a tension controller, an anilox roller, or a combination thereof determines the amount of edible adhesive placed on the image.

6. The method of claim 1, wherein the printing plate is a flexographic printing plate.

7. The method of claim 1, wherein the printing plate is mounted to the roller using tape, magnets, straps, or a combination thereof.

8. The method of claim 1, wherein the edible adhesive is clear, colored, flavored, or combinations thereof.

9. The method of claim 1, wherein the edible coating is formed from a particulate.

10. The method of claim 1, wherein the edible coating comprises sugar, spice, seasoning, color, or combinations thereof.

11. The method of claim 1, wherein the edible coating comprises starch, salt, vegetable protein, animal protein, yeast, vegetable powder, garlic, garlic powder, fat, gums, preservatives, natural flavors, artificial flavors, and combinations thereof.

12. The method of claim 1, wherein the edible coating has a flavor selected from the group consisting of mesquite, lemon, pepper, peppercorn, Caribbean jerk, buffalo, chipotle, garlic, sesame ginger, Szechuan, teriyaki and combinations thereof.

13. The method of claim 1, wherein a mandrel delivers the edible coating in metered quantities to the substrate.

14. A method of transferring an edible image to foodstuff comprising:
mounting a printing plate having an image thereon to a roller;
depositing an edible adhesive onto the image;
transferring the edible adhesive from the printing plate to a substrate thereby transferring a mirror copy of the image onto the substrate;
depositing an edible coating onto the edible adhesive, wherein the mirror copy of the image comprises the edible adhesive and the edible coating;
contacting the substrate with foodstuff; and
subjecting the foodstuff to a vacuum until at least a portion of the image transfers to the foodstuff.

15. The method of claim 14, wherein the image is substantially transferred to the foodstuff.

16. The method of claim 14, wherein the substrate is removed before cooking the foodstuff.

17. The method of claim 14, wherein the substrate is not removed before cooking the foodstuff.

18. The method of claim 14, wherein the foodstuff is selected from the group consisting of protein, cheese, candy, fruit, vegetable, baked goods, bread, pastry, cake, and dough.

19. The method of claim 14, wherein the edible adhesive is clear, colored, flavored, or combinations thereof.

20. The method of claim 14, wherein the edible coating comprises sugar, spice, seasoning, color, or combinations thereof.
